(19) United States
(12) Patent Application Publication
(10) Pub. No.: US 2013/0143520 A1
(43) Pub. Date: Jun. 6, 2013

(54) ENHANCING CONNECTIVITY AT SOCIAL AND TELECOMMUNICATION NETWORKS

(71) Applicants: Yigang Cai, Naperville, IL (US); Helmut Raether, Shorewood, IL (US); Ranjan Sharma, New Albany, OH (US)

(72) Inventors: Yigang Cai, Naperville, IL (US); Helmut Raether, Shorewood, IL (US); Ranjan Sharma, New Albany, OH (US)

(21) Appl. No.: 13/310,174

(22) Filed: Dec. 2, 2011

(51) Int. Cl. H04W 4/00

(52) U.S. Cl. 455/405

(57) ABSTRACT

A system for enhancing connectivity at a social network. The system is able to identify a user of a telecommunication network, to access charging records for the user pertaining to sessions over the telecommunication network, and to analyze the charging records for the user to determine a pattern of communication relating the user to another individual. The system is further able to determine that the user is a member of a social network, and to provide information regarding the determined pattern of communication to the social network.

### FIELD OF THE INVENTION

The invention relates to the fields of social networking and telecommunications.

### BACKGROUND

Social networks include systems, applications, and websites for establishing social connections among multiple users. For example, social networks include generalized networks (e.g., Facebook), professional networks (e.g., LinkedIn), and networks that are centered around the common interests of users (e.g., eHarmony). Users are drawn to social networks because social networks increase the opportunity for person-to-person interactions. At the same time, operators of social networks desire a user base capable of generating valuable revenue streams.

As presently practiced, social networks attempt to increase the amount of time that users spend in-network (e.g., the amount of time spent with applications for the social network, websites for the social network, etc.), and further attempt to acquire detailed information about users. This in turn allows the social network to provide users with relevant advertising targeted to their interests. For example, if a social network user has many friends interested in a given sport, that user is potentially receptive to advertising for that sport. When social networks are heavily utilized and have access to detailed user information, their potential revenue from advertising becomes significant.

Operators of social networks have determined that as users form more social connections on the network, they are more likely to spend time on the network, and are less likely to leave the network. Therefore, social networks generally attempt to foster connections between users. For example, the social network may analyze existing connections (e.g., “friendships”) between users on the network in order to provide recommendations to form new connections between users.

### SUMMARY

Embodiments described herein advantageously utilize information normally unavailable to a social network, and use this information to facilitate the creation of connections at the social network. For example, charging records of a telecommunication (telecom) system normally used for billing purposes may be analyzed in order to infer social connections between individuals. By analyzing these charging records (which are not generally publicly available), a telecom provider may recommend that users update account information at a social network in order to show the connection at the social network. Fostering the generation of connections on the social network in turn enhances user loyalty and targeted advertising opportunities. Thus, the value of the social network may be increased.

One embodiment is a system for enhancing connectivity at a social network. The system is able to identify a user of a telecommunication network, to access charging records for the user pertaining to sessions over the telecommunication network, and to analyze the charging records for the user to determine a pattern of communication relating the user to another individual. The system is further able to determine that the user is a member of a social network, and to provide information regarding the determined pattern of communication to the social network.

In further embodiment, the system is also able to suggest that the social network recommend a change to social network account information for the user based upon the pattern of communication.

Another embodiment is a method for enhancing social network connectivity. The method comprises identifying a user of a telecommunication network, accessing charging records for the user pertaining to sessions over the telecommunication network, and analyzing the charging records for the user to determine a pattern of communication relating the user to another individual. The method further comprises determining that the user is a member of a social network and providing information regarding the determined pattern of communication to the social network.

Another embodiment is a system for enhancing user service plans at a telecommunication network. The system is operable to identify a telecommunication network user associated with a social network account, to access account information for the user pertaining to actions of the user on the social network, and to analyze the account information of the user to relate the user to another member of the social network. The recommendation system is further operable to provide a recommendation for changing a service plan of the user at the telecommunication network based upon the account information.

Yet another embodiment is a method for enhancing user service plans at a telecommunication network. The method comprises identifying a telecommunication network user associated with a social network account, accessing account information for the user pertaining to actions of the user on the social network, and analyzing the account information of the user to relate the user to another member of the social network. The method further includes providing a recommendation for changing a service plan of the user at the telecommunication network based upon the account information.

Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a recommendation system in communication with a telecommunication network and a social network in an exemplary embodiment.

FIG. 2 is a flowchart illustrating a method for utilizing telecommunication charging records to recommend connections at a social network in an exemplary embodiment.

FIG. 3 is a flowchart illustrating a method for utilizing social network account information to recommend changes in service plans for a telecommunication system in an exemplary embodiment.

FIG. 4 is a block diagram illustrating an application server of an IMS network coupled for communication with a social network in an exemplary embodiment.

FIG. 5 illustrates an application providing a prompt to generate a connection at a social network via a mobile device in an exemplary embodiment.

FIG. 6 is a block diagram illustrating a social network receiving a request from a mobile device to update a user's profile information in an exemplary embodiment.

FIG. 7 is an illustration of a webpage for an updated social network profile viewed via an Internet browser in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

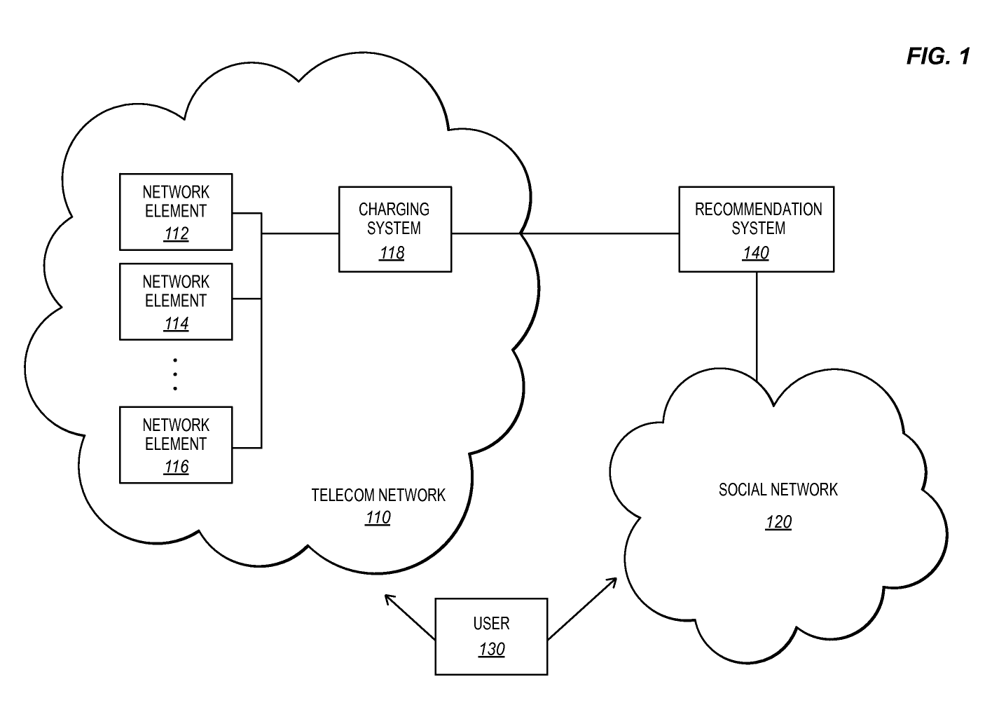

FIG. 1 is a block diagram of a recommendation system 140 in communication with a telecommunication (telecom) network 110 and a social network 120 in an exemplary embodiment. Recommendation system 140 may access and analyze charging records of telecom network 110 to promote a greater level of connectivity between users of social network 120. Charging records typically indicate the actions of network devices as they engage in sessions (e.g., data sessions, voice sessions, SMS events, etc.) via telecom network 110. Charging records may include, for example, Charging Data Records and/or Call Detail Records of telecom network 110. Both types of charging records are referred to herein with the term “CDR.” According to FIG. 1, telecom network 110 includes network elements 112-116, which are operable to generate information for charging system 118.

Telecom network 110 may comprise any of a variety of implementations of wireless and/or wireline telecommunication systems (e.g., 3G, 4G, LTE networks, IP Multimedia Subsystem (IMS), circuit-switched networks, etc.). Network elements 112-116 may comprise any network components for facilitating the operation and/or capabilities of telecom network 110. For example, in an IMS network, network elements 112-116 may include Call Session Control Functions for Proxy (P-CSCF), Serving (S-CSCF), and/or Interrogating (I-CSCF). Network elements 112-116 may further include a generator operable to create charging records from information sent via telecom network 110. This generator may populate a repository with generated charging records. For example, in an IMS network, the generator may comprise a Charging Collection Function (CCF) operable to populate a repository with a plurality of CDRs.

Charging system 118 comprises any system, component, or device operable to perform charging functions based upon actions performed via telecom network 110. For example, charging system 118 may generate bills based upon CDRs stored at a repository.

Social network 120 comprises an Internet-implemented network providing websites and/or applications for facilitating social interactions between multiple users. For example, social network 120 may comprise a set of websites and applications dedicated to professional networking, friendships, dating, hobbies, etc.

Typically, social network 120 will be external to and/or independent from telecom network 110 (i.e., charging records of telecom network 110 will be unavailable to social network 120, and account information of social network 120 will be unavailable to telecom network 110). However, it is possible that social network 120 and telecom network 110 may both have access to certain types of information. In one embodiment, updates to social network 120 may be transmitted via a mobile device of a user of telecom network 110 (e.g., in a text message, browser, etc.). This information may therefore be received and stored at social network 120. The mobile device and/or charging records of telecom network 110 may also log this information (e.g., as a record of previously transmitted text messages, browsing history, etc.).

In FIG. 1, one or more users 130 are active on both telecom network 110 and social network 120. As such, telecom network 110 may include a large volume of valuable information useful for forming connections on social network 120 that relate to one or more users 130. However, this information is not normally available to social network 120. Recommendation system 140 bridges the information gap between telecom network 110 and social network 120, thereby enhancing connectivity at social network 120.

Recommendation system 140 comprises any system, device, or component operable to identify patterns of communication for users of telecom network 110 and provide information based upon these patterns of communication to social network 120 in order to enhance connectivity. For example, recommendation system 140 accesses charging records and determines patterns of communication for users based on those charging records. In one embodiment, recommendation system 140 further determines potential social connections between users based upon the patterns of communication, and indicates these potential social connections to social network 120. While recommendation system 140 is depicted as independent from telecom network 110, in some embodiments recommendation system 140 may be implemented at telecom network 110 (e.g., as an application server) or at social network 120 (e.g., as a computer server).

Assume for this embodiment that telecom network 110 manages a variety of sessions for telecom users relating to voice, data, and/or other services. Charging system 118 acquires session information generated by network elements 112-116, and generates charging records based upon the session information. A repository is populated with the charging records, and the charging records include a history of valuable user actions that are not normally available to social network 120.

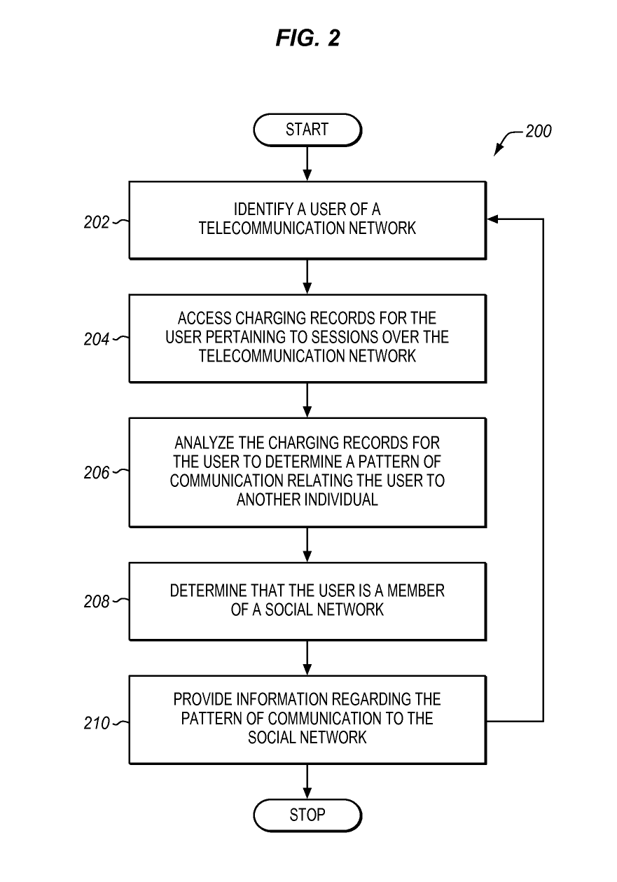

FIG. 2 is a flowchart illustrating a method 200 for utilizing telecom charging records to enhance connectivity at social network 120 in an exemplary embodiment. The steps of method 200 are described with reference to recommendation system 140 of FIG. 1, but those skilled in the art will appreciate that method 200 may be performed in other systems. The steps of the flowcharts described herein are not all inclusive and may include other steps not shown. The steps described herein may also be performed in an alternative order.

In step 202, recommendation system 140 identifies a user of telecom network 110. For example, recommendation system 140 may identify users listed in a subscriber database of telecom network 110. In one embodiment, users are identified based upon a request from social network 120 that indicates a set of phone numbers or other telecom IDs. In step 204, recommendation system 140 accesses charging records for the identified user that pertain to sessions over telecom network 110. The charging records accessed by recommendation system 140 may include data session information indicating interests of the user, call session history of the user, geolocation of the user at a given time, purchases made by the user, and other information.

In step 206, recommendation system 140 analyzes the charging records for the user to determine a pattern of communication relating the user to another individual. Patterns of communication include actions performed via a telecom network that associate a user with other individuals. One example of a pattern of communication is a history of call sessions or data sessions between the user and the other individual. In a further example, a user's history of locations, purchases made via telecom network 110, data sessions via telecom network 110, and other communications create a pattern that relates the user to another individual. Thus, patterns of communication may be determined even if direct communications between the user and the other individual are minimal or nonexistent. For example, if they purchase similar items, travel to similar locations at similar times, etc., they may have a potential social connection. In one embodiment, the other individual does not have to be a member of the same telecom network as the user, but may be a member of a different telecom network. As long as the charging records for the user provide some sort of information linking the user to the other individual, a pattern of communication may be found.

In step 208, recommendation system 140 determines that the user is a member of a social network 120. Social network 120 may be external to and independent from telecom network 110 (i.e., account information for the two networks may be separate, the networks may be part of different companies, etc.). In one embodiment, recommendation system 140 determines that a telecom ID for the user is associated with the social network (e.g., by determining that a phone number, private ID, or public ID of the user is part of a social networking profile).

In step 210, recommendation system 140 provides information regarding the pattern of communication to social network 120. This may be accomplished in a number of ways. For example, recommendation system 140 may simply provide the pattern of communication directly to social network 120 and allow social network 120 to determine social connections from the pattern. In one example, selected patterns of communication are provided (e.g., patterns of communication that are expected to be most relevant, based upon a given rule set for recommendation system 140). In another example, recommendation system 140 provides a suggestion indicating one or more social connections that are likely based upon the pattern of communication. From this point, recommendation system 140 may repeat steps 202-210 in order to determine multiple connections between multiple users. Recommendation system 140 may provide this information in batch form or as a series of individual recommendations for transmission to social network 120.

Utilizing the information provided by recommendation system 140, social network 120 provides a suggestion to the user of telecom network 110. Social network 120 may suggest that the user update their social network profile information based upon the received information. For example, social network 120 may determine, based upon the pattern of communication, that the other individual is likely a “friend” of the user on the social network. Social network 120 may therefore update a “recommended friends list” for the user. In another example, recommendations may be prioritized based upon whether the recommendation is new to social network 120 or not.

Utilizing the method of FIG. 2, a telecom network 110 may provide valuable information to social network 120 that would normally be unavailable to social network 120. This information may be used in order to facilitate the creation of connections at social network 120, which in turn provides social network 120 with an increased level of user loyalty and/or advertising revenue. Furthermore, because telecom network 110 does not need to provide the actual charging records of its users, the potential privacy issues for users of telecom network 110 are minimized.

In one embodiment, recommendation system 140 further recommends that social network 120 suggest that a user change their account information based upon the pattern of communication. Further, recommendation system 140 may determine a potential social connection between the user and the other individual based upon the pattern of communication. For example, recommendation system 140 may make this determination by applying a rule set stored in memory to the pattern of communication. By applying the rule set to the pattern of communication, recommendation system 140 may determine whether a social connection is likely to exist. The connection will typically indicate a family relationship, friendship, professional connection, shared interest, etc., although other connections may also be used. This potential connection may be determined based upon a variety of factors defined by the rule set. For example, the potential connection may be determined based upon the number and type of purchases made by the users, the time of day of sessions between users, day of the week of sessions between users, time between sessions, and length of sessions between users. In one embodiment, recommendation system 140 reviews a history of similar geolocations for the users at similar times in order to determine a potential connection. Further methods for determining potential social connections are described in the following papers, which are herein incorporated by reference: “Mobile social group sizes and scaling ratio,” Santi Phithakkitnukoon and Ram Dantu, A I & Soc (2011) 26:71-85; “Inferring Social Groups Using Call Logs,” Santi Phithakkitnukoon and Ram Dantu, OnTheMove Federated Conference (OTM 2008)—The International Workshop on Community-Based Evolution of Knowledge-Intensive Systems (COMBEK'08), LNCS 5333, Monterrey, Mexico, November 2008; “Discovery of Social Groups Using Call Detail Records,” Huiqi Zhang and Ram Dantu, World Wide Web Internet And Web Information Systems (2008), 489-498. While potential connections will typically indicate unrealized connections between two already-existing users on social network 120, a potential connection may also include a suggestion to invite an individual to join social network 120.

In a further embodiment, it may be desirable to consider the privacy concerns of users of telecom network 110 (or social network 120) before sending information outside of those networks. In this example, recommendation system 140 is further operable to analyze account information for users to determine whether that user has authorized the release of information (e.g., to telecom network 110 or social network 120). If the user does not authorize the release, recommendation system 140 blocks the information from being provided. This may be particularly important, as privacy laws are likely to govern the publication of personal information by telecom network 110 and social network 120. Privacy information may be stored at recommendation system 140, telecom network 110, social network 120, or an external component that links social network accounts to subscribers of telecom network 110. The privacy controls may, for example, be implemented as “opt in” or “opt out” choices by users.

In another embodiment, recommendation system 140 may provide information to social network 120 through a variety of channels. For example, recommendation system 140 may provide the information directly to applications for users of social network 120. In this example, recommendation system 140 provides the information from step 210 to applications (“apps”) for users of the social network that reside on the users' mobile devices (e.g., cellular phones, tablets, e-readers, etc.). In another example, the information is provided directly to computer servers of social network 120.

In a further embodiment, charging records of telecom network 110 indicate phone numbers (or other telecom IDs) for a given session, but don't indicate the identity of people who are associated with those phone numbers. In such cases, users may be identified, for example, by acquiring a telecom ID for a device identified in the charging record, and correlating the identifier with a subscriber of telecom network 110.

In a still further embodiment, recommendation system 140 may acquire charging records directly from one or more mobile devices of telecom network 110 (instead of from a charging record repository). This may be beneficial in cases where recommendation system 140 has been tasked with generating recommendations for a specific user of telecom network 110.

While FIG. 2 illustrates the use of telecom network information to facilitate connectivity at a social network, the process may also work in the reverse direction. For example, a user's social network information may be used to suggest changes to the user's service plan at a telecom network.

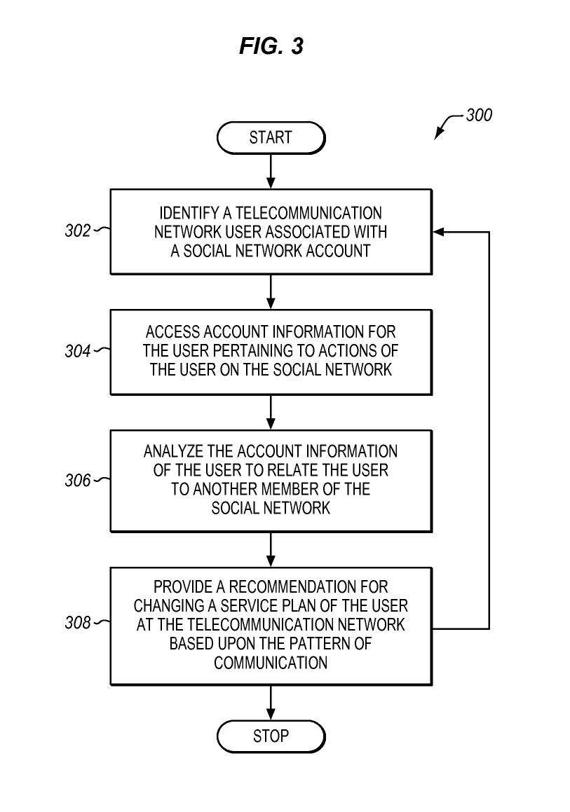

FIG. 3 is a flowchart illustrating a method 300 for utilizing social network account information to recommend changes in service plans for a telecom network 110 in an exemplary embodiment. Method 300 utilizes information normally unavailable to telecom network 110, owing to privacy concerns, and uses this information in order to provide recommendations to telecom network 110. While the steps of method 300 are described with reference to recommendation system 140 of FIG. 1, those skilled in the art will appreciate that method 300 may be performed in other systems. Additionally, steps for method 300 may further include details discussed above with regard to similar steps of method 200.

In step 302, recommendation system 140 identifies an account on social network 120 associated with a user of telecom network 110. This may be performed, for example, by reviewing the account information of social network 120 to determine a listed telecom ID (e.g., telephone number, public identifier, private identifier) for the social network account. This telecom ID may then be correlated with a device and/or subscriber of telecom network 110.

In step 304, recommendation system 140 accesses account information for the user that pertains to actions of the user on social network 120. The account information may be stored, for example, at an account database of social network 120. In one embodiment, the account information is stored at a personal computing device of the user that is accessible by a server of social network 120. Account information may include profile settings (e.g., user name, password, identifying information, privacy and sharing information, etc.) as well as historic interactions at social network 120 (e.g., histories/timelines of interaction, posts to the network, messages via social network 120, purchases or “likes” on social network 120, and/or friendship or other social connection information on social network 120).

In step 306, recommendation system 140 analyzes the account information of the user to relate the user to another member of the social network. For example, a pattern of interaction between the user and the other member may indicate that a social connection exists between them. The pattern may be determined based upon an internal rule set of recommendation system 140.

In step 308, recommendation system 140 provides a recommendation for changing a service plan of the user based upon the account information. For example, recommendation system 140 may suggest that the user change the quantity and identity of those who use mobile devices in a shared service plan with the user, the identity of “friends and family” identified by the user (e.g., those who are “free to call”), the number of minutes (or amount of data) available for the service plan, addition or removal of international plans, etc. In one embodiment, the recommendation is that the user add the other member of the social network to a shared service plan. From this point, recommendation system may repeat steps 302-308 in order to provide multiple recommendations. Note that in some embodiments, method 300 may include steps for ensuring user privacy similar to those described above with regard to method 200.

Utilizing the method of FIG. 3, a social network 120 may provide valuable information to telecom network 110 that would normally be unavailable to telecom network 110. This information may be used in order to streamline changes in service plans for users of telecom network 110, which in turn enhances customer experiences at telecom network 110. Furthermore, because social network 120 does not need to provide the private account information of users to telecom network 110, the potential privacy issues for users of social network 120 are minimized.

### EXAMPLES

In the following examples, additional processes, systems, and methods are described for recommendation systems.

Further examples are illustrated in the context of an IMS network operable to review Charging Data Records and Call Detail Records (both herein referred to as CDRs) in order to make sets of recommendations to a social network.

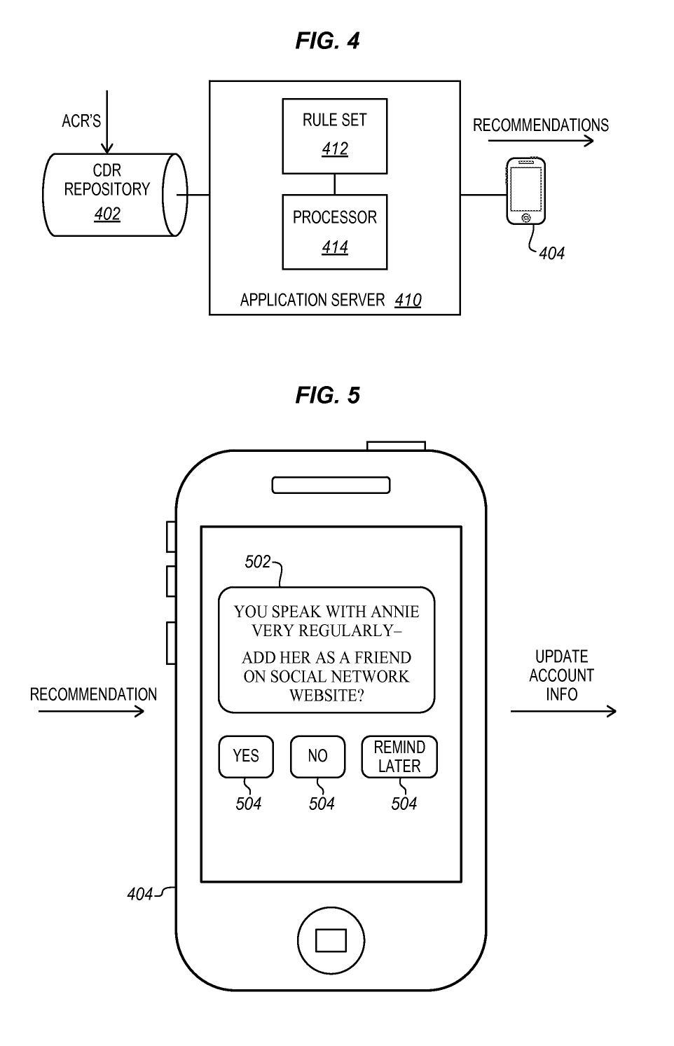

FIG. 4 is a block diagram illustrating an application server 410 of an IMS network coupled for communication with a social network in an exemplary embodiment. In this embodiment, a CCF of the IMS network acquires Accounting Requests (ACRs) from multiple network elements, generates CDRs based on the ACRs, and stores the CDRs at CDR repository 402. In this embodiment, recommendation system 140 is implemented as a component of application server 410. Application server 410 accesses CDR repository 402 in order to analyze the CDRs stored therein. Application server 410 identifies users indicated in CDRs of CDR repository 402, and determines a pattern of communication (calls, texts, pictures messages, video messages, etc.) between users based on the CDRs. Application server 410 uses rule set 412 stored in memory and implemented by processor 414 to determine patterns of communication from the CDRs. For example, based upon the time of day, day of the week, and frequency of communications, application server 410 determines a likelihood of a social connection between given users. In a further example, application server 410 determines whether a given pair of telecommunication devices are likely being used by friends or co-workers based upon the pattern of communication (e.g., weekday, business-hour communications are likely to indicate co-workers, while weekday, after-hours communications are likely to indicate friends). Application server 410 generates a batch of recommendations for a social network based on the patterns of communication. These recommendations are transmitted out to “apps” for the social network that reside on one or more mobile devices 404.

FIG. 5 illustrates an application providing a prompt 502 to generate a connection at a social network via a mobile device 404 in an exemplary embodiment. According to FIG. 5, a recommendation from application server 410 is received at mobile device 404 via a social networking application residing on mobile device 404. The social networking application presents a prompt 502 to the user suggesting that the user add another individual as a friend on the social network. The prompt 502 is accompanied by a variety of options 504. Assume, for this embodiment, that the user decides to accept the recommendation. Mobile device 404 therefore transmits an instruction to update the user's account information to reflect the friendship.

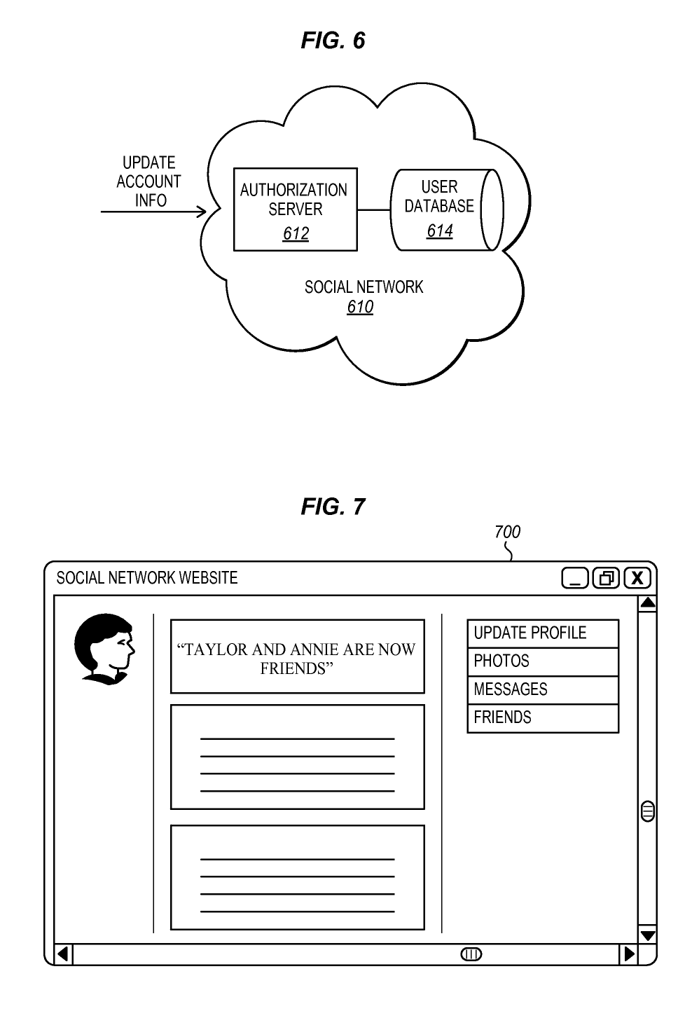

FIG. 6 is a block diagram illustrating a social network 610 receiving a request from a mobile device 404 to update a user's profile information in an exemplary embodiment. According to FIG. 6, the request is first interpreted by an authorization server 612 of social network 610. The authorization server confirms that the request is a genuine request from the correct user of social network 610 and not an unauthorized attempt to alter the account. Authorization server 612 therefore directs the request to user database 614, where the change is implemented to indicate the friendship between the user and the other individual.

FIG. 7 is an illustration of a webpage for an updated social network profile 700 viewed via an Internet browser in an exemplary embodiment. According to this example, social network profile 700, when viewed via the web browser, indicates the change in friendship status to other users of social network 610.

In a further embodiment, application server 410 selectively provides recommendations to social network 610. Application server 410 queries social network 610 to determine which telecom users are members of social network 610. Application server 410 then removes the recommendations relating to users that are not represented on the social network, and provides the remaining recommendations to the social network.

Any of the various elements shown in the figures or described herein may be implemented as hardware, software, firmware, or some combination of these. For example, an element may be implemented as dedicated hardware. Dedicated hardware elements may be referred to as “processors,” “controllers,” or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
a recommendation system operable to identify a user of a telecommunication network, to access charging records for the user pertaining to sessions over the telecommunication network, and to analyze the charging records for the user to determine a pattern of communication relating the user to another individual;
the recommendation system further operable to determine that the user is a member of a social network, and to provide information regarding the pattern of communication to the social network.

2. The system of claim 1 wherein
the recommendation system is further operable to suggest that the social network recommend a change to social network account information for the user based upon the pattern of communication.

3. The system of claim 1 wherein
the recommendation system is further operable to analyze subscriber information for the user to determine whether the user authorizes the release of information to the social network, to provide the information responsive to determining that the user authorizes release, and to block the information responsive to determining that the user does not authorize release.

4. The system of claim 1 wherein
the recommendation system is further operable to provide the information to a mobile device of the user via an application for the social network.

5. The system of claim 1 wherein
the recommendation system is further operable to determine the pattern of communication based upon lengths of sessions between the user and the other individual.

6. The system of claim 1 wherein
the recommendation system is further operable to determine the pattern of communication based upon a number of sessions instituted between the user and the other individual over a period of time.

7. The system of claim 1 wherein
the recommendation system is further operable to determine the pattern of communication based upon similar geolocations between the user and the other individual occurring at similar times.

8. The system of claim 1 wherein
the recommendation system is further operable to determine the pattern of communication based upon purchases made by the user and the other individual.

9. A method comprising:
identifying a user of a telecommunication network;
accessing charging records for the user pertaining to sessions over the telecommunication network;
analyzing the charging records for the user to determine a pattern of communication relating the user to another individual;
determining that the user is a member of a social network; and
providing information regarding the pattern of communication to the social network.

10. The method of claim 9 further comprising:
suggesting that the social network recommend a change to social network account information for the user based upon the pattern of communication.

11. The method of claim 9 further comprising:
analyzing subscriber information for the user to determine whether the user authorizes the release of information to the social network;
providing the information responsive to determining that the user authorizes release; and
blocking the information responsive to determining that the user does not authorize the release.

12. The method of claim 9 wherein the transmitting comprises:
providing the information to a mobile device of the user via an application for the social network.

13. The method of claim 9 wherein the determining the pattern of communication comprises:
determining the pattern of communication based upon lengths of sessions instituted between the user and the other individual.

14. The method of claim 9 wherein the determining the pattern of communication comprises:
determining the pattern of communication based upon a number of sessions between the user and the other individual over a period of time.

15. The method of claim 9 wherein the determining the pattern of communication comprises:
determining the pattern of communication based upon similar geolocations between the user and the other individual occurring at similar times.

16. The method of claim 9 wherein the determining the pattern of communication comprises:
determining the pattern of communication based upon purchases made by the user and the other individual.

17. A system comprising:
a recommendation system operable to identify a telecommunication network user associated with a social network account, to access account information for the user pertaining to actions of the user on the social network, and to analyze the account information of the user to relate the user to another member of the social network;
the recommendation system further operable to provide a recommendation for changing a service plan of the user at the telecommunication network based upon the pattern of communication.

18. The recommendation system of claim 17 wherein
the recommendation system is further operable to provide a recommendation for including the other member of the social network in a shared service plan for the user at the telecommunication network.

19. A method comprising:
identifying a telecommunication network user associated with a social network account;
accessing account information for the user pertaining to actions of the user on the social network;
analyzing the account information of the user to relate the user to another member of the social network; and
providing a recommendation for changing a service plan of the user at the telecommunication network based upon the account information.

20. The method of claim 19 wherein
the recommendation suggests including the other member of the social network in a shared service plan for the user at the telecommunication network.
